(19) United States
(12) Patent Application Publication
(10) Pub. No.: US 2014/0267333 A1
(43) Pub. Date: Sep. 18, 2014

(54) IMAGE DISPLAY DEVICE AND IMAGE DISPLAY METHOD

(71) Applicant: Funai Electric Co., Ltd., Daito, Osaka (JP)

(72) Inventor: Kensuke Kono, Daito (JP)

(21) Appl. No.: 14/351,132

(22) PCT Filed: Oct. 26, 2012
(86) PCT No.: PCT/IB2012/002153

§ 371 Date: Apr. 10, 2014

(30) Foreign Application Priority Data
Nov. 8, 2011 (JP) 2011-244756

(51) Int. Cl. G09G 5/06; G06T 1/60

(52) U.S. Cl. CPC G09G 5/06; G06T 1/60
USPC 345/531

(57) ABSTRACT

An image display device includes a memory component, a color specification component and a display component. The memory component stores frame data that forms a display image, a color table that stores color data for each selection condition with the color data being indicative of a plurality of colors specified to the frame data, and reference data that associates the selection condition with the color data of the color table. The color specification component specifies the color data to the frame data based on the reference data according to the selection condition. The display component generates the display image based on the frame data and the color data.

### CROSS-REFERENCE TO RELATED APPLICATIONS

This application claims priority to Japanese Patent Application No. 2011-244756 filed on Nov. 8, 2011. The entire disclosure of Japanese Patent Application No. 2011-244756 is hereby incorporated herein by reference.

### BACKGROUND

1. Field of the Invention

The present invention generally relates to an image display device. More specifically, the present invention relates to an image display device for displaying a specific image.

2. Background Information

Conventionally, there have been times when a given product is sold with the color of a specific image changed to suit the brand or destination where the product will be sold. For example, if a distinction is made between “brand 1” and “brand 2” by image color, then when the same product is sold under each brand, the color of an OSD image that can be manipulated by the user may be assigned according to whether the product is “brand 1” or “brand 2.” Accordingly, conventionally, image data for each brand or destination has been recorded to a memory contained in the product so as to accommodate each brand or destination (see Japanese Laid-Open Patent Application Publication Nos. 2008-145663, 2004-54087 and 2005-346096, for example).

### SUMMARY

As described above, to accommodate a number of brands or destinations with a single product, it is of course necessary to store image data corresponding to all of these brands or destinations. However, if the number of color gradations that can be reproduced is large, then that means more information will be stored in the memory. For example, if a certain product is able to display 256 gradations, then the amount of information for at least a single set of image data will be the product of multiplying the number of pixels by the gradation value. Accordingly, as the number of brands or destinations increases, there is attendant increase in the amount of memory usage.

One object of the present disclosure is to provide an image display device with which memory resources can be used effectively, without increasing the amount of information, even when there is a function of changing the color of a displayed image for each certain condition.

In view of the state of the know technology, an image display device includes a memory component, a color specification component and a display component. The memory component is configured to store frame data that forms a display image, a color table that stores color data for each selection condition with the color data being indicative of a plurality of colors specified to the frame data, and reference data that associates the selection condition with the color data of the color table. The color specification component is configured to specify the color data to the frame data based on the reference data according to the selection condition. The display component is configured to generate the display image based on the frame data and the color data.

Other objects, features, aspects and advantages of the present disclosure will become apparent to those skilled in the art from the following detailed description, which, taken in conjunction with the annexed drawings, discloses selected embodiments of an image display device.

### BRIEF DESCRIPTION OF THE DRAWINGS

Referring now to the attached drawings which form a part of this original disclosure:

FIG. 1A is a diagram of an OSD image displayed by an image display device in accordance with a first embodiment;

FIG. 1B is an enlarged diagram of the OSD image displayed by the image display device, illustrating bitmap data forming the OSD image;

FIG. 2 is a block diagram of the image display device;

FIG. 3A is a diagram of a brand specification table stored in the image display device illustrated in FIG. 2;

FIG. 3B is a diagram illustrating relationship between data and tables stored in memories of the image display device illustrated in FIG. 2;

FIG. 4 is a flowchart illustrating the display of the OSD image with the image display device illustrated in FIG. 2;

FIG. 5 is a flowchart illustrating the display of an OSD image in accordance with a second embodiment;

FIG. 6A is a diagram illustrating a color table serving as a base color table for generating a combined color table;

FIG. 6B is a diagram illustrating a color table serving as a difference color table for generating the combined color table; and

FIG. 7 is a block diagram illustrating an image display device in accordance with a third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

Referring initially to FIGS. 1A to 5, an image display device 1 is illustrated in accordance with a first embodiment. FIG. 1A is a diagram of an OSD image displayed by the image display device 1. FIG. 1B is an enlarged diagram of the OSD image. FIG. 2 is a block diagram of the image display device 1. FIG. 3A is a diagram illustrating a table stored in the image display device 1. FIG. 3B is a diagram illustrating relationship between data and tables stored in the image display device 1.

The image display device 1 functions as a television receiver. Therefore, the image display device 1 is used in a state in which it is connected to an antenna (not shown), and can display an image based on video data inputted from this antenna. As shown in FIG. 1A, the image display device 1 also displays an OSD (on-screen display) image on the screen upon input through operation of a remote control 2 or other such device. This OSD image is displayed using OSD data, in which color data has been specified to the frame data, produced internally by the image display device 1.

As shown in FIG. 2, the image display device 1 includes a digital board 10 and a display 20. The digital board 10 is connected to the antenna on the input side, and is connected to the display 20 via an LVDS cable 30 on the output side. In other words, with this configuration, the digital board 10 extracts video data pertaining to a specific channel from a television broadcast received by the antenna, subjects this video data to specific processing, and then outputs it through the LVDS cable 30 to the display 20.

The display 20 is a liquid crystal display, for example, and includes a display main body and a driver. The display main body is made up of pixels of R (red), G (green), and B (blue) according to the resolution. The driver subjects the video data received through the LVDS cable 30 to digital-analog conversion, and then produces a drive voltage for driving the pixels. The pixels and the driver are connected by wiring. The drive voltage is supplied through this wiring to the pixels.

The digital board 10 includes a tuner 11, a video memory 12, a main controller 13, a palette reference memory 14, a color palette memory 15, and an interface 16. The tuner 11, the video memory 12, the main controller 13, and the interface 16 are connected via a bus (such as an I2C bus), and are able to communicate with each other. The video memory 12, the palette reference memory 14 and the color palette memory 15 forms a memory component or recording means of the present application.

The main controller 13 performs overall control of the operation of the image display device 1 by executing programs stored in an internal memory (not shown). The main controller 13 also functions as an OSD component 13a and an image processor 13b. In its function as the image processor 13b, the main controller 13 subjects the various kinds of video data stored in the video memory 12 to pixel count conversion, color correction, and other such processing. In its function as the OSD component 13a, the main controller 13 produces OSD data for displaying OSD images.

In this embodiment, the main controller 13 includes a microcomputer with a control program that controls the operation of the image display device 1 as discussed below. The main controller 13 can also include other conventional components such as an input interface circuit, an output interface circuit, and memory circuits such as a ROM (Read Only Memory) device and a RAM (Random Access Memory) device. The microcomputer of the main controller 13 is programmed to control the operation of the image display device 1. The memory circuit stores processing results and control programs such as ones for controlling the image display device 1 that are run by the microcomputer. The internal RAM of the main controller 13 stores statuses of operational flags and various control data. The internal ROM of the main controller 13 stores the control programs for various operations. The main controller 13 is capable of selectively controlling any of the components connected thereto in accordance with the control program. It will be apparent to those skilled in the art from this disclosure that the precise structure and algorithms for the main controller 13 can be any combination of hardware and software that will carry out the functions of the present application. Furthermore, the palette reference memory 14 and the color palette memory 15 can include any memory circuits suitable for storing tables, such as a ROM device, a RAM device and so forth.

The OSD image is an image that is displayed on the screen when the user operates a specific key on the remote control 2 or the like. An example of the OSD image is shown in FIG. 1A, in which are displayed a banner image EG1 that makes this OSD image more aesthetically pleasing, icon boxes EGN (where N is an integer from 2 to 7) labeled with the character strings EW1 for making various kinds of settings for “PICTURE,” “SOUND,” “SETUP,” “FEATURE,” “LANGUAGE,” and “Blu-ray” (“Blu-ray” is a registered trademark), a cursor EG8 that is displayed in an inverted color when one of the icons are selected, and other character strings EW2. Also, a logo image (e.g., logo data or log mark) indicating the brand (or brand name) of the image display device 1 is displayed in the banner image EG1. In this embodiment, the various components that make up the OSD image will also be called “constituent elements”.

The character strings EW1 and EW2 are the constituent elements with no change in the specified color due to brand names or destinations where the image display device 1 is sold, while the banner image EG1, the icon boxes EG2 to EG7, and the cursor EG8 are those with a change in the specified color due to brand or destination. The OSD image discussed here is nothing but an example, and can be suitably modified according to the configuration of the OSD image. A selection of brand names or destinations forms a selection condition of the present application as discussed below.

FIG. 1B is a detail enlarged diagram illustrating a part of the OSD image shown in FIG. 1A. As shown in FIG. 1B, the OSD data is made up of bitmap data in which a specific number of bits or pixels are arranged in the x and y directions. Color data is specified for the bits or pixels (xi, yj) that make up the bitmap data from among the 256 colors selected from among 1024 colors. Also, of the various bits, the bits that make up the above-mentioned constituent elements are given as frame data. For example, the banner image EG1 is constituted by imparting specific color data to frame data, which is a grouping of bits that make up this image. Here, “color data” means a color reproduced by mixing the R, G, and B color elements, or a color reproduced by just one of the R, G, and B color elements. This frame data is stored in the video memory 12. In particular, as shown in FIG. 3B, specific colors have not assigned to the pixels of the frame data (or bitmap data in FIG. 3B) while the frame data is stored in the video memory 12. Only color IDs are assigned to the pixels of the frame data while the frame data is stored in the video memory 12. For example, as shown in FIG. 3B, 4-bit color ID is assigned to each pixel of the frame data. In other words, in the frame data, 4-bit color ID is associated with a position of each pixel of the frame data.

With the image display device 1, the color ID is used to specify some color data out of the 1024 colors to each of the bits. This color ID is associated with whichever color data is recorded to a color table CLUT (discussed below). For instance, in this embodiment, 256 colors of color data selected from among 1024 colors of color data are recorded to the color table CLUT. The color ID corresponds to whichever of the 256 colors of color data is recorded to the color table CLUT. In this embodiment, the color ID is set for each bit. However, the color ID can instead be given using the above-mentioned constituent elements as one unit. In this embodiment, even though the maximum number of gradations that can be reproduced by the image display device 1 is more than 1024, the color table CLUT only specifies 256 colors that is less than the maximum number of gradations.

In the palette reference memory 14 are stored a brand specification table 14a for referring to the color table CLUT corresponding to the specified brand or destination, and a reference table RLUT listing color data identified by the color ID of the OSD data fro each brands.

Specifically, as shown in FIG. 3A, various brands are recorded in the brand specification table 14a so as to be associated with the reference tables RLUT and the color tables CLUT on a one-to-one basis. In this embodiment, there are five different brands “A” to “E,” so five reference tables RLUT 1 to 5 and five color tables CLUT 1 to 5 are stored so as to be associated with these brands. In this case, selecting one of these five different brands “A” to “E” forms selecting of selection condition of the present application. For example, selecting the brand “A” corresponds to selecting a first condition while selecting the brand “B” corresponds to selecting a second condition.

Also, the reference tables RLUT are stored in the palette reference memory 14 according to the number of brands specified by the brand specification table 14a. In other words, if five different brands “A” to “E” can be displayed as mentioned above, then five kinds of the reference tables RLUT 1 to 5 with different combinations of color data are stored in the palette reference memory 14. Here, color IDs associated with the each bits, and color data stored in any of the color tables CLUT are stored in the reference table RLUT so as to be associated on a one-to-one basis. The arrangement of the color data is stipulated for arrangement order according to the gradation value of the R, G, and B color elements.

The color table CLUT in which is stored the color data specified by the color ID is stored in the color palette memory 15 for each brand. In other words, if five different brands “A” to “E” can be displayed as mentioned above, then five kinds of the color tables CLUT 1 to 5 with different combinations of the color data are stored in the color palette memory 15. Further, 8-bit (i.e., 256 colors) color data selected ahead of time from among 10-bit (i.e., 1024 colors) color data is stored in a specific arrangement (i.e., 256 rows of 0 to 255 as shown in FIG. 3B) to each color table CLUT. Also, gradation values for each of the R, G, and B colors that will be the color elements of this color data are stored and associated with each set of color data. The sets of color data stored in the color table CLUT are arranged in the order of the gradation values of R, G, and B that become the color elements.

With this image display device 1, the brand specification table 14a and the reference tables RLUT form a “reference data” of the present application. Also, the color tables CLUT form a “color table” of the present application.

FIG. 4 is a flowchart illustrating the display of the OSD image by the image display device 1. In the flowchart shown in FIG. 4, the color data and the logo data specified to the various bits of the OSD data are selected in steps S10 to S30. Then, the color data is specified in steps S40 and S50, and the OSD image is displayed in steps S60 and S70.

In step S10, the main controller 13 (e.g., the OSD component 13a) receives the selection of one of the brands of the image display device 1. This processing allows input when the factory shipment mode of the image display device 1 has been selected. A case in which the remote control 2 is operated to select the brand “A” will be described first as an example.

In step S20, the main controller 13 (e.g., the OSD component 13a) selects one of the reference tables RLUT and one of the color tables CLUT according to the classification of the received brand. That is, the main controller 13 refers to the brand specification table 14a stored in the palette reference memory 14, and selects the reference table RLUT and the color table CLUT corresponding to the brand selected in step S10. For example, when the brand “A” is selected as discussed above, the main controller 13 refers to the brand specification table 14a to select the reference table RLUT1 and the color table CLUT1 corresponding to the brand “A” in the brand specification table 14a. Naturally, if the brand “B” is selected, the main controller 13 refers to the brand specification table 14a, and refers to the reference table RLUT2 and the color table CLUT2 corresponding to the brand “B.” Thereafter, the selected reference table RLUT and the selected color table CLUT are used to continue selecting the various color data for the OSD image.

In step S30, the main controller 13 (e.g., the OSD component 13a) selects the logo data according to the classification of the received brand. When the brand “A” is selected as mentioned above, the logo data corresponding to this brand “A” is selected from an internal memory (not shown).

In step S40, the main controller 13 (e.g., the OSD component 13a) specifies the color data to be given to the frame data that makes up the OSD data. That is, first the main controller 13 selects the color data corresponding to the color ID associated with each of the bits (xi, yj) that make up the frame data, on the basis of one of the reference tables RLUT corresponding to the selected brand. The main controller 13 then selects each color data specified by the reference table RLUT from one of the color tables CLUT corresponding to the specified brand, and acquires the R, G, and B values that make up this selected color data.

In step S50, the man controller 13 determines whether or not color data has been specified for all of the frame data (i.e., bits (xi, yj)) that make up the OSD data. If color data has not been specified for all of the frame data (i.e., bits (xi, yj)) that make up the OSD data (No in step S50), then the main controller 13 (e.g., the OSD component 13a) repeats the processing (i.e., the processing of step S40) until color data has been specified for all of the bits.

On the other hand, if color data has been specified for all of the frame data (Yes in step S50), then in step S60 the main controller 13 (e.g., the OSD component 13a) uses the logo data and the color data specified for each bit to produce display data (e.g., display image). That is, the main controller 13 performs specification of color data for each of the bits (xi, yj), and superposes the logo data over this bit data to produce the display data for output to the display 20. Consequently, the processing of steps S40 and S50 (or the OSD component 13a of the main controller 13) forms a color specification component or color specification means of the present application.

Then, in step S70, the main controller 13 outputs the produced display data through the LVDS cable 30 to the display 20, and displays the OSD image. Accordingly, the OSD image is displayed in which a specific color has been given to the logo mark and the frame data according to the selected brand. Consequently, the processing in steps S60 and S70 (or the OSD component 13a of the main controller 13 and the display 20) forms a display component or display means of the present application.

As shown in FIG. 1, as an example, with the OSD image displayed on the display 20, the colors of the banner image EG1, of the icon boxes EG2 to EG7 and of the cursor EG8 for selecting the icons, as well as the logo image, change according to the selected brand.

In this first embodiment, as described above, the image display device 1 separately stores the frame data including configurations other than color data, and the color data specified to this frame data according to the brand or destination. Thus, the OSD image that corresponds to the brand or destination can be displayed merely by changing the color data specified to the frame data. Also, the color data is merely stored in the color tables CLUT stored corresponding to the number specified by the conditions (i.e., the number of brands or destinations). Thus, the amount of information stored or memory capacity can be reduced.

### Second Embodiment

Referring now to FIGS. 5 to 6B, an image display device in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical or functionally identical to the parts of the first embodiment may be omitted for the sake of brevity.

This second embodiment differs from the first embodiment in that the color table CLUT for each brand is made up of a color table CLUT (e.g., a first table) that serves as a base or standard (e.g., a first table corresponding to a first condition), and at least one color table CLUT (e.g., at least a second table) that is other than this base color table CLUT (e.g., a second table corresponding to a second condition) and records only the difference from the base color table CLUT. Specifically, this second embodiment is the same as the first embodiment in that the color tables CLUT are recorded to the color palette memory 15 according to the number of brands, but differs in that only the differences from the base color table CLUT are recorded in the color tables CLUT (i.e., difference color tables) other than the base color table CLUT. Thus, the image display device in accordance with the second embodiment basically has an identical configuration as the image display device 1, except for the operation of the main controller 13 to obtain a color table CLUT for specifying the color data to the frame data based on both the base color table GLUT and the difference color table GLUT, and except for the configuration of the tables stored in the color palette memory 15. Thus, the detailed description of the image display device in accordance with the second embodiment will be omitted for the sake of brevity.

FIG. 5 is a flowchart illustrating the display of the OSD image by the image display device. FIG. 6A is a diagram illustrating the base color table CLUT1. FIG. 6B is a diagram illustrating the difference color table CLUT2. In the following description, a case in which the color table CUT serving as the base or standard is called the base color table CLUT1, and other color tables CUT are called the difference color tables CLUT 2 to 5, will be described as an example.

In step S110, the selection of a brand is received. As an example, the following description will be of a case of operating the remote control 2 to input the selection of the brand “B” (i.e., a selection of a second condition).

In step S120, the main controller 13 refers to the brand specification table 14a and selects one of the reference tables RLUT and one of the color tables CLUT according to the classification of the received brand. When the brand “B” is selected as discussed above, the main controller 13 refers to the brand specification table 14a and selects the reference table RLUT2 and the difference color table CLUT2 corresponding to brand “B,” as shown in FIG. 3A.

As shown in FIG. 6A, just as in the first embodiment, 256 colors of color data selected from among 1024 colors of color data are stored in the base color table CLUT1 in an arrangement according to the gradation values of the color elements. Meanwhile, as shown in FIG. 6B, of the arrangement, only color data that is different from that of the base color table CLUT1 are stored in the difference color table CLUT2. Therefore, the storage of RGB color elements to the same color data as that stored in the base color table CLUT1 is omitted in the difference color table CLUT2, for example. In FIG. 6B, the color data in the fourth to sixth rows from the top of the arrangement of the difference color table CLUT2 is the same as the color data stored in the base color table CLUT1. Thus, the RGB values that become the color elements for the color data in the fourth to sixth rows in the difference color table CLUT2 are omitted. On the other hand, since the color data in the other rows are unique to the difference color table CLUT2 or different from the base color table CLUT1, those RGB color elements are stored.

The selection of the base color table CLUT1 serving as a benchmark or standard is made by selecting the one with the smallest average saturation of the color data among the color tables CLUT that are stored in the color palette memory 15. A known conversion method can be used to calculate the saturation from the RGB values.

The base color table CLUT1 has the lowest average saturation of all the other color tables CLUT in the distribution of color data. As mentioned above, the base color table CLUT1 is selected using the one with the lowest average saturation. Therefore, (i) there is most redundant or overlapping color data between the base color table CLUT1 and the other color tables CLUT, and (ii) it is possible to avoid failure, such as an arithmetic overflow, in the production of the base color table CLUT1 and the other color tables CLUT. In particular, in (i) above, since there is less difference between the base color table CLUT1 and the other difference color tables CLUT, it is possible to reduce the amount of color data stored in the difference color tables CLUT other than the base color table CLUT1.

In step S130, the main controller 13 selects the logo data according to the received brand classification. Here, since the brand “B” has been selected, for example, the main controller 13 selects the logo data corresponding to the brand “B.”

In step S140, the main controller 13 determines whether or not the color table CLUT corresponding to the specified brand is the base color table CLUT1. If the color table CLUT corresponding to the specified brand is one other than the base color table CLUT1 (No in step S140), then in step S150 the main controller 13 combines the base color table CLUT1 and one of the difference color tables CLUT other than the base color table CLUT1 that corresponds to the specified brand to produce a combined color table CLUT′. For example, the main controller 13 modifies the base color table CLUT1 based on the information stored in the difference color table CLUT2 to produce a combined color table CLUT′2 corresponding to the brand “B.” In other words, the main controller 13 specifies the color data to the frame data based on both the base control table CLUT1 and the difference color table CLUT2.

On the other hand, if the color table CLUT pertaining to the specified brand is the base color table CLUT1 (Yes in step S140), then in step S160 the main controller 13 uses only the base color table CLUT1 selected in step S120 to specify the color data.

In step S160, the main controller 13 uses the base color table CLUT1 or the combined color table CLUT′ produced in step S150 to specify the color data to be given to the various frame data forming the OSD data. Specifically, the main controller 13 selects the color data corresponding to the color ID associated with the bits (xi, yj) forming each frame data based on the reference table RLUT, and acquires the color elements (i.e., the R, G, and B values) of the selected color data from the base color table CLUT1 or the combined color table CLUT′.

In step S170, the main controller 13 determines whether or not the color data has been specified for all of the frame data forming the OSD data. If the color data has not been specified for all of the frame data constituting the OSD data (No in step S170), then the main controller 13 repeats the processing (i.e., the processing of step S160) until the color data has been specified for all of the frame data.

On the other hand, if the color data has been specified for all of the frame data (i.e., all of the bits (xi, yj)) (Yes in step S170), then in step S180 the main controller 13 uses the logo data and the color data specified for each frame data to produce the display data.

In step S190, the main controller 13 outputs the produced display data through the LVDS cable 30 to the display 20, and displays the OSD image. Accordingly, the OSD image displaying the logo mark and the specific color according to the brand (e.g., the brand “B”) is displayed on the display 20.

As described above, in addition to the configuration that is the same as in the first embodiment, in this second embodiment the color data for each brand or destination is made up of the data (e.g., the base color table) serving as a standard or base and the data (e.g., the difference color tables) that stores only the arrangement of the color data different from that of the base data. Thus, the amount of information stored in the recording means (e.g., the color palette memory 15) can be reduced.

### Third Embodiment

Referring now to FIG. 7, an image display device in accordance with a third embodiment will now be explained. In view of the similarity between the first and second embodiments and the third embodiment, the parts of the third embodiment that are identical to the parts of the first and second embodiments will be given the same reference numerals as the parts of the first and second embodiments. Moreover, the descriptions of the parts of the third embodiment that are identical or functionally identical to the parts of the first and second embodiments may be omitted for the sake of brevity.

FIG. 7 is a block diagram illustrating an image display device 1 in accordance with the third embodiment. The image display device 1 is identical to the image display device 1 shown in FIG. 2, except that the image display device 1 shown in FIG. 7 is configured to allow connection to a server 200 via a network N, such as the Internet, LAN, WAN, and so forth. The server 200 stores the color tables CLUT (e.g., the difference color tables CLUT) other than the color table CLUT (e.g., the base color table CLUT1) serving as the standard or base in a hard disk drive (HDD) of the server 200. That is, the third embodiment differs from the first and second embodiments in that the place where the color tables CLUT other than the color table CLUT serving as the base color table are stored in the server 200.

More specifically, the color palette memory 15 of the image display device 1 only stores the color table CLUT serving as the standard or base (i.e., the base color table CLUT1) (e.g., a first table of the color table associated with a first condition of the selection condition). The server 200 stores the color tables CLUT (i.e., the difference color tables CLUT) other than the color table CLUT serving as the standard or base (e.g., a color table that stores color data for each selection condition other than the first condition). The color table CLUT serving as the standard or base (i.e., the base color table CLUT1) has the color data with the lowest average saturation among the color tables CLUT stored in the color palette memory 15 and the server 200.

With this configuration, for example, in step S120 in FIG. 5, the main controller 13 downloads one of the color tables CLUT corresponding to the specified brand, etc., from the server 200. In particular, when the brand “B” is selected (e.g., in response to selecting the second condition), then the main controller 13 downloads or acquire the difference color table CLUT2 that corresponds to the brand “B.” Then, in step S150 the main controller 13 uses both the downloaded color table CLUT2 and the base color table CLUT1 stored in the image display device 1 to produce the combined table CLUT′ for specifying the color data to the frame data.

With this configuration, it is possible to manage the color tables CLUT other than the color table CLUT serving as the base color table with the server 200. Thus, the image display device 1 need only store one color table CLUT (i.e., the base color table CLUT1). Therefore, the amount of information stored in the memory (e.g., the color palette memory 15) can be greatly reduced.

### Other Embodiments

There are many different embodiments of the present application. The image display device 1 equipped with the function of the television receiver is one example. The present application can be applied to any display device that is capable of outputting image data for displaying a specific image, or a reproduction device that reproduces data recorded to a specific medium.

Also, with the image display device 1, the reference data is formed by the brand specification table 14a and the reference tables RLUT. However, the reference data can be formed by the reference tables RLUT and the color tables CLUT. Moreover, the reference data can be formed only by the color tables CLUT. In this case, each of the color tables CLUT are associated with conditions, such as brands or destinations, and includes color IDs and RGB color elements corresponding to the color IDs, respectively. Then, once one of the brands is selected, then the selection of one of the color tables CLUT is made based on the selected brand. Furthermore, based on the color IDs specified for the bits forming the bitmap data, the RGB color elements are selected from the selected color table CLUT.

This application relates to an image display device for displaying a specific image. More specifically, this application relates to an image display device for changing display color of the specific image according to its use, such as brands or destination.

This application relates to an image display device for displaying a specific image. The image display device comprises recording means for recording frame data that is data for displaying an image and whose color has not been specified, a color table for recording a plurality of colors for each specific selection condition, the number being less than the number of gradations that can be reproduced by the image display device, and reference data that is associated with the selection condition and with color data recorded to the color table; color specification means for specifying the color data to the frame data by referring to the reference data according to the selected selection condition; and display means for displaying an image pertaining to the frame data based on the specified color data.

With this image display device, the frame data, the color table and the reference data are recorded to the recording means. The color table records the plurality of colors for each specific selection condition. The colors are specified to the frame data and the number of colors is less than the number of gradations that can be reproduced by the image display device. The reference data is associated with the specific selection condition and with color data recorded to the color table. Specifically, as the color data recorded to the color table, only the color data selected as needed from among the color data that can be reproduced by the image display device is recorded for each selection condition. The color specification means specifies the color data to the frame data by referring to the reference data according to the selection condition that has been previously selected. That is, since the color data specified to a constituent element is recorded to the reference data for each selection condition, when a certain selection condition has been selected, the color specification means performs the specification of color data corresponding to this selection condition by referring to the reference data.

Here, any selection condition can be recorded to the reference data here, so long as it is for the reason of changing the color of an image to distinguish it from other images. For example, the selection condition can be the brand specified for the image display device, or the destination of the image display device.

The display means then performs the display of frame data using the color data specified by the color specification means. Accordingly, an image is displayed on the image display device in a color that matches the selected condition.

Also, the configuration can be such that the color table includes a first table for recording the color data associated with a first condition included in the selection condition, and at least a second table for recording the color data associated with a second condition. The color data that is different from the color data recorded to the first table is recorded to the second table. When the color specification means specifies the color data according to the second condition, the first table and the second table are used to specify the color data.

With this image display device, since only the difference from the color data recorded to the first table is recorded to the second table, the amount of information can be reduced.

The first table can have the lowest average saturation of the recorded color data.

With this image display device, the first table, to which the color data with the lowest average saturation is recorded, is used as a base or standard for other tables. Thus, the difference between the first table and the other tables can be reduced, and the amount of information can be decreased.

Furthermore, this image display device can be configured such that it can be connected via a network to a server that manages at least the second table. The color specification means downloads the second table from the server.

With this image display device, the amount of information recorded to the recording means can be further reduced by managing everything but the first table on the server.

Moreover, the frame data can be displayed as an OSD image.

With this configuration, the present application can be applied to displaying the OSD image.

Also, the selection condition can be a classification of the brand specified for the image display device.

With this image display device, memory resources can be used effectively, without increasing the amount of information, even when there is a function of changing the color of a displayed image for each certain condition.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

It should be apparent to those skilled in the art that the present invention is not limited to the embodiments given above, but the following modification can be made without departing from the scope of the invention: suitably combining and changing the mutually interchangeable members, configurations, and so forth disclosed in the above embodiments; suitably substituting or combining and changing the interchangeable member, configuration, and so forth disclosed in the above embodiments with those that are not disclosed in the above embodiment but are conventionally known; and suitably substituting or combining and changing the member, configuration, and so forth that are not disclosed in the above embodiments with those that are apparent modifications to those skilled in the art based on the conventionally known technique as replacements for the member, configuration, and so forth disclosed in the above embodiment.

1. An image display device comprising:
a memory component configured to store frame data that forms a display image, a color table that stores color data for each selection condition with the color data being indicative of a plurality of colors specified to the frame data, and reference data that associates the selection condition with the color data of the color table;
a color specification component configured to specify the color data to the frame data based on the reference data according to the selection condition; and
a display component configured to generate the display image based on the frame data and the color data,
the memory component being further configured to store a first table of the color table associated with a first condition of the selection condition, and
the color specification component being further configured to produce a combined color table based on both the first table and a second table associated with a second condition of the selection condition in response to selecting the second condition of the selection condition, and specify the color data to the frame data based on the combined color table.

2. The image display device according to claim 1, wherein
the memory component is further configured to store the second table of the color table associated with the second condition of the selection condition, with the second table storing different color data from the first table, and
the color specification component is further configured to specify the color data to the frame data based on both the first table and the second table in response to selecting the second condition of the selection condition.

3. The image display device according to claim 2, wherein
the first table has the color data with the lowest average saturation among the color table.

4. The image display device according to claim 1, wherein
the color specification component is further configured to acquire the second table associated with the second condition of the selection condition via a network from a server that has a color table that stores color data for each selection condition other than the first condition in response to selecting the second condition of the selection condition.

5. The image display device according to claim 4, wherein
the color specification component is further configured to specify the color data to the frame data based on both the first table and the second table in response to selecting the second condition of the selection condition.

6. The image display device according to claim 4, wherein
the first table has the color data with the lowest average saturation among the color tables stored in the memory component and the server.

7. The image display device according to claim 1, wherein
the frame data forms an OSD image displayed by the display component.

8. The image display device according to claim 1, wherein
the selection condition includes a selection of brand specified to the image display device.

9. The image display device according to claim 1, wherein
the selection condition includes a selection of destination of the image display device.

10. The image display device according to claim 1, wherein
the frame data includes a color ID associated with each pixel forming the frame data, and
the reference data includes a reference table that associates the color ID with the color data for each selection condition.

11. The image display device according to claim 10, wherein
the color specification component is configured to select the reference table and the color table according to the selection condition.

12. The image display device according to claim 1, wherein
the color data of the color table is indicative of the colors whose number is less than maximum number of gradations reproduced by the image display device.

13. An image display method comprising:
providing frame data that forms a display image, a color table that stores color data for each selection condition with the color data being indicative of a plurality of colors specified to the frame data, and reference data that associates the selection condition with the color data of the color table;
selecting the selection condition;
specifying the color data to the frame data based on the reference data according to the selection condition; and
generating the display image based on the frame data and the color data,
the providing of the color table including providing a first table of the color table associated with a first condition of the selection condition, and
the specifying of the color date to the frame data including producing a combined color table based on both the first table and a second table associated with a second condition of the selection condition in response to selecting the second condition of the selection condition, and specifying the color data to the frame data based on the combined color table.
